(19) United States
(12) Patent Application Publication
(10) Pub. No.: US 2014/0303993 A1
(43) Pub. Date: Oct. 9, 2014

(54) SYSTEMS AND METHODS FOR IDENTIFYING FRAUD IN TRANSACTIONS COMMITTED BY A COHORT OF FRAUDSTERS

(71) Applicant: Matthew Florian, Fort Collins, CO (US)

(72) Inventor: Matthew Florian, Fort Collins, CO (US)

(73) Assignee: UNISYS CORPORATION, Blue Bell, PA (US)

(21) Appl. No.: 14/244,138

(22) Filed: Apr. 3, 2014

Related U.S. Application Data
(60) Provisional application No. 61/809,707, filed on Apr. 8, 2013.

(51) Int. Cl. G06F 19/00

(52) U.S. Cl. CPC G06F 19/328
USPC 705/2

(57) ABSTRACT

Disclosed are systems and methods for identifying potential fraud committed by a cohort of people using models for identifying relationships among people to build the cohort and using fraud models to identify indicators of frauds from attributes of people. Embodiments may predict a likelihood applicants seeking privileges to distribute governmental benefits by identifying members of a cohort associated with an applicant, assigning a value to the strengths of the relationships between people in the cohort, determining weights for identified indicators of fraud identified using fraud models, determining a risk score for the cohort using the values and data points, and then performing a clustering analysis for the risk score of the cohort to determine a risk factor for fraud committed by the applicant and the cohort.

### CROSS-REFERENCE TO RELATED APPLICATIONS

This application claims priority to U.S. Provisional Patent Application Ser. No. 61/809,707, filed Apr. 8, 2013, entitled “Provide Management Fraud Models.” which is incorporated by reference in its entirety.

### FIELD OF THE DISCLOSURE

The subject matter disclosed herein relates generally to identifying fraud committed by a cohort of people.

### BACKGROUND

Models for providing patients with state-funded health care funds, such as Medicare, begin with health care providers, such as a hospital or doctor's office, to file for reimbursement of funds when treating patients seeking healthcare support from the state. Often, state health care systems may be susceptible to fraud committed by any number of dubious actors. One of the common patterns of fraud is fraud committed by a network of perpetrators acting in concert versus a single dubious individual.

Fraud networks operate by several perpetrators operating in collusion, which makes identifying fraud difficult by committing individual instances of fraud across multiple bad acts. A view of the fraud is spread thin since it is difficult to identify and pinpoint each of the individual fraudulent events. Conventional techniques for detecting operate on by detecting thresholds of behavior for multiple transactions of a single person. Fraud networks, operating as a collaborative of multiple people, do not reach a given threshold, and thus the collusion hides the network's activities.

Conventional tools may identify a single fraudster using background checks, checking for outstanding or past allegations of fraud, and/or reviewing criminal history. In some cases, network of fraudsters operate as an identifiable cohort working together to commit the intended fraud. In such cases, a problem with conventional tools is that, while conventional tools may identify an individual, those conventional tools are limited to scrutinizing just one particular individual. Conventional tools cannot effectively scrutinize and identify a network of known associates.

Conventional tools typically only have a means for characterizing risks that an individual may pose in the process of selecting an applicant as a Medicaid or other support provider. However, in scenarios in which an individual is a member of a cohort of individuals sharing in the fraudulent behavior, the individual may be held out as a front to the Medicaid provider activity while in reality, thus the purported Medicaid provider is actually working with a cohort behind the scenes to facilitate fraudulent activity. Conventional tools typically lack the means for detecting such concerted efforts.

What is needed is a means for identifying fraudulent activity committed by a network of fraudsters. What is needed is a means for identifying and characterizing various indicators of risk that may trigger a warning against an applicant seeking to provide Medicaid. What is needed is a means for processing applications efficiently while also effectively screening against potential fraudsters; particularly against a network or cohort of fraudsters.

### SUMMARY

The embodiments disclosed herein attempt to address the above failings of the art and provide a number of other benefits. These systems and methods may identify potential fraud committed by a cohort of people using relationship models for training software modules to identify relationships among people to identify a cohort of people, and using fraud models to identify indicators of fraud found in attributes of people. Embodiments may predict a likelihood applicants seeking privileges to distribute governmental benefits by identifying members of a cohort associated with an applicant, assigning a value to the strengths of the relationships between people in the cohort, determining weights for identified indicators of fraud identified using fraud models, determining a risk score for the cohort using the values and data points, and then performing a clustering analysis for the risk score of the cohort to determine a risk factor for fraud committed by the applicant and the cohort. Some embodiments may search governmental databases. Some embodiments may search external, open data sources such as public websites. Some embodiments may implement web crawler program for automatically searching and data mining for information relating to the new applicant, identifying associates to include in the cohort, and identifying indicators of fraud.

In one embodiment, a computer-implemented method for processing applications to provide publicly-funded health benefits, in which the method comprises: searching, by the computer, a first database storing one or more prior applicants associated with one or more characteristics; identifying, by the computer, one or more associates of a new applicant having one or more characteristics of the prior applicants in the first database, wherein an associate is a prior applicant having one or more relationships to the new applicant based upon one or more characteristics common with the new applicant; identifying, by the computer, one or more indicators of fraud in the first database associated with one or more people in a cohort comprising the new applicant and the one or more associates; assigning, by the computer, a weight to each of the identified indicators of fraud using a classification model; and calculating, by the computer, a risk score for the new applicant using each of the weights assigned to the one or more identified fraud indicators.

In another embodiment, a benefits provider application system configured to mitigate fraud by a cohort, in which the system comprises a provider application database storing in memory one or more applications received from one or more prior applicants seeking to distribute a government benefit, wherein each prior applicant is associated with one or more attributes; and a server comprising a processor configured to: receive a new application from a new applicant having one or more attributes; identify one or more associates having a relationship with the new applicant from the one or more prior applicants, wherein the relationship between an associate and the new applicant is based upon one or more common attributes; identify one or more indicators of fraud for the new applicant and each of the one or more associates using one or more fraud models identifying a set of one or more attributes as being indicators of fraud; and determine a risk factor for the new applicant based upon a risk score determined by the one or more indicators of fraud identified for the new applicant and each of the one or more associates.

### BRIEF DESCRIPTION OF THE DRAWINGS

The present disclosure can be better understood by referring to the following figures. The components in the figures are not necessarily to scale, emphasis instead being placed upon illustrating the principles of the disclosure. In the figures, reference numerals designate corresponding parts throughout the different views.

FIG. 1 is a diagram showing an exemplary system embodiment for detecting fraud committed by a cohort of people.

FIG. 2 is a flowchart showing steps of an exemplary method embodiment of identifying potential fraud committed by a cohort.

### DETAILED DESCRIPTION

The present disclosure is here described in detail with reference to embodiments illustrated in the drawings, which form a part here. Other embodiments may be used and/or other changes may be made without departing from the spirit or scope of the present disclosure. The illustrative embodiments described in the detailed description are not meant to be limiting of the subject matter presented here.

Reference will now be made to the exemplary embodiments illustrated in the drawings, and specific language will be used here to describe the same. It will nevertheless be understood that no limitation of the scope of the invention is thereby intended. Alterations and further modifications of the inventive features illustrated here, and additional applications of the principles of the inventions as illustrated here, which would occur to one skilled in the relevant art and having possession of this disclosure, are to be considered within the scope of the invention.

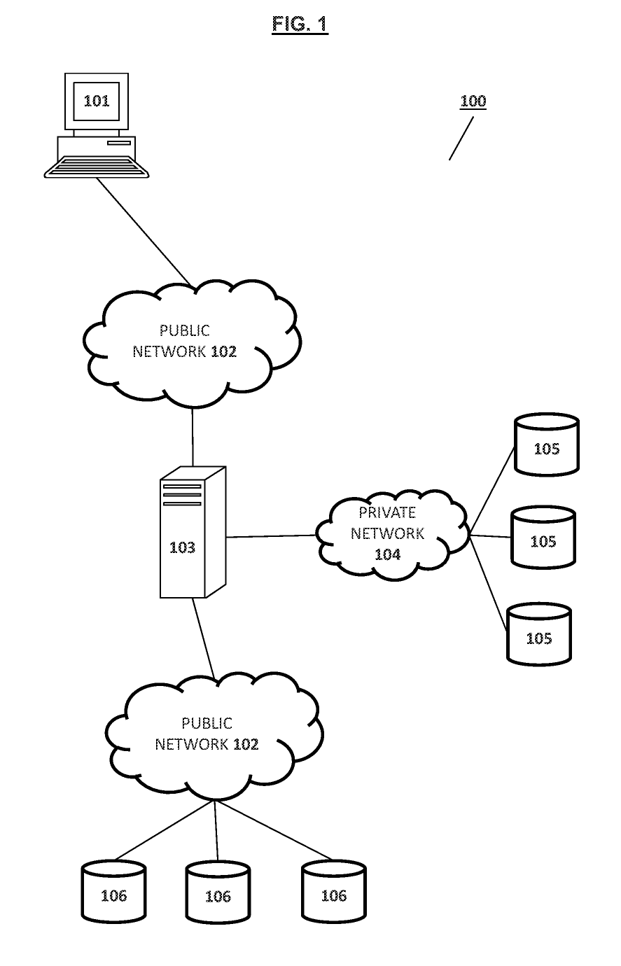

FIG. 1 is a diagram showing an exemplary system embodiment for detecting provider fraud utilizing a cohort. The fraud detection system 100 of FIG. 1 may comprise one or more personal computers 101, a public network 102, a central server 103, a private network 104, one or more private data sources 105, and one or more open sources 106.

Embodiments of a fraud detection system 100 may comprise one or more personal computers 101 utilized by various parties. A personal computer 101 may be any computing device comprising a processor capable of a implementing software modules and performing tasks as described herein (e.g., desktop computer, laptop computer, tablet, smart phone, server computer). In some implementations of the system 100, a personal computer 101 may be associated with an applicant to provide state-issued benefits, such as Medicare or Medicaid. In some implementations of the system 100, a personal computer 101 may be associated with a party to a financial transaction.

In implementations of a fraud detection system 100 mitigating fraud in governmental benefits systems, such as a healthcare benefits system, the fraud detection system 100 may evaluate applications received from healthcare providers applying to be eligible to distribute government-funded benefits for patients. The personal computer 101 may be associated with such a healthcare provider applying to provide benefits, or new applicant, submitting data to a central server 103 that facilitates and/or manages a vetting process for new applicants and data collection regarding prior applicants.

Embodiments of a fraud detection system 100 may comprise a public network 102 facilitating communications between the personal computer 101 and a central server 103 of the fraud detection system 100. Embodiments of the public network 102 may be any combination of computing devices, software modules, and/or other technology capable of facilitating the communications between personal computers 101, central servers 103, and one or more open data sources 106 such as news websites and social media websites.

Embodiments of a fraud detection system 100 may comprise a central server 103. Embodiments of a central server 103 may be computing devices comprising a processor capable of a implementing software modules and performing tasks as described herein. In some embodiments, a central server 103 may comprise a single computing device having a processor. In some embodiments, the central server comprise a plurality of computing devices operating in concert as a distributed computing model. In some embodiments, the fraud detection system 100 may comprise a plurality of central servers 103 providing redundancy and/or load balancing.

A central server may 103 execute software modules instructing processors to perform fraud detection as described herein. In some embodiments, the central server 103 may receive a new application from a new applicant. In some embodiments, a paper copy of a new application may be put into a computer-readable format to create a computer file. It is to be appreciated that the new application is not limited to the paper application. It is to be appreciated that the new application may be any computer-readable file containing information regarding the new applicant and allowing for fraud detection by the modules of the central server 103.

Embodiments of a fraud detection system 100 may comprise a private network 104 facilitating communication between the modules of the central server 103 and one or more private data sources 105. Embodiments of the private network 104 may comprise any combination of computing devices, software modules, and/or other technology capable of facilitating the communications between the central server 103 and private data sources 105. In some embodiments, the fraud detection system 100 may comprise networked computers (not shown) capable of communicating over the private network 104 and providing administrative staff remote communications with the central server 103 and/or private data sources 105. In some embodiments, the private network 104 may implement various network security protocols, devices, and/or software modules prohibiting unauthorized users and/or devices from communicating over the private network 104.

Embodiments of a fraud detection system 100 may comprise one or more private data sources 105. A private data source 105 may be any source of information capable of being searched by communicatively coupled devices. In some embodiments, the private data source may be implement security protocols and/or software modules for prohibiting unauthorized users and/or devices from communicating and/or accessing the private data source 105. In some embodiments, private data sources 105 may be various databases and modules of one or more governmental entities. In some embodiments, private data sources 105 may be various database and modules of a commercial transaction broker or lender.

In some embodiments, a private data source 105 may be a database comprising a non-transitory machine-readable storage medium storing data records comprising information regarding applicants applying for privileges to provide benefits. In some embodiments, the database of the private data source 105 may be a component of a government benefits system storing data records regarding previous applications (including applications under review), prior applicants, and application histories. In some embodiments, the private data source 105 may be a law enforcement database storing data records regarding prior criminal history, ongoing criminal investigations, watch lists, and other information regarding documented suspicious behavior for evaluating applicants applying to provide benefits.

In some embodiments, a central server 103 may be execute a search of private data sources 105 for information relating to a new applicant. In some embodiments, the central server 103 may determine whether a new applicant is already stored in records of prior applicants found in private data sources 105. In some embodiments, the central server 103 may search for known associates of the new applicant among records found in the private data sources 105. In some embodiments, the central server 103 may begin searching for known associates in the prior applicant records of a database of a private data source 105 that is associated with a benefits administration entity. In some embodiments, the central server 103 may progressively move from a first private data source 105 (e.g., database for benefits administration entity) to a next private data source 105 (e.g., law enforcement database), at each private data source 105 searching for information identifying known associates and other information concerning evaluation of a new applicant.

Identifying information may include characteristics of individuals presenting some relationship with the new applicant. Non-limiting examples of such characteristics identifying a relationship with the new applicant may include names, addresses, criminal histories, work addresses, and occupations, among other types of information capable of identifying a relationship between individuals.

Embodiments of a fraud detection system 100 may access information from one or more open data sources 106. Embodiments of an open data source may be any data source available for public search and retrieval. Non-limiting examples of open data sources 106 may include publicly-available government websites/webpages (e.g., police blotter, court records), public websites (e.g., news media, blogs), and social networking websites.

In some embodiments, a central server 103 may execute a search for pertinent information regarding a new applicant over a public network 102. Searches of open sources 106 regarding a new applicant may return identifying information of the new applicant (e.g., addresses, names, occupation). For example, a social media profile of a new applicant may suggest that the new applicant previously resided in a particular city, which may confirm the identify of the new applicant or may strengthen the likelihood that the new applicant matches a prior applicant who is already in the health benefits system.

Searches of open sources 106 regarding a new applicant may return information relating to indicators of fraud, such as information suggesting a criminal history of the new applicant or a history of fraud committed with identified associates in a cohort. For example, an news media website may report a story about an incident of fraud involving the new applicant. As another example, the news media website may report a story about the new applicant being involved with a prior applicant, thereby strengthening the likelihood the two people have a relationship. Searches of open sources 106 regarding a new applicant may also identify previously unidentified potential associates of the new applicant. That is, known associates of the new applicant that should be part of a cohort might not be immediately found during searches of private data sources 105. However, searching open sources 106 may identify people associated with the new applicant who may be included into the cohort.

In some embodiments, the central server 103 may implement a computer program, or web crawler, which may automatically search private data sources 105 and/or open sources 106 based on parameters that may be input by human users and/or dynamically generated and/or updated. Non-limiting examples of parameters for the web crawler may include names, events, how many links the web crawler may follow when traversing a website, a timeline boundary limiting how far back in time a web crawler may identify information.

As an example of the web crawler, in some embodiments, the web crawler may be sent by the central server 103 to search local news sources and public filings at a local administration. The parameters may be set at the time of execution with a client computing device. Parameters in this example may include a timeline boundary for searching webpages within a number of years of age. Within the time period between the instant search going as far back as the boundary, the web crawler may identify and return all of the information stored by the local new sources. In this example, the web crawler may return a text file of information at each particular data source.

In some embodiments, once a web crawler returns the information from private data sources 105 and/or open data sources 106, a central server 103 may process data returned by the web crawl using entity resolution and/or relationship modules to identify a name or names of the new applicant, and then, if the processing identifies the new applicant in data from a particular source, then the processing may search for other names within that article that by reference are associated with the new applicant. In some embodiments, the processing in the central server 103 may determine a strength of the relationship between the other names mentioned in a particular source, and then determine what to do with the other names based on the strength of the relationship. That is, a name appearing in a source may not have a strong relationship with the new applicant based on the source and other available data, and therefore the other name may not be the name of someone having a notable relationship with the new applicant that should be added to a cohort. However, in some embodiments, this processing may find that the two names (i.e., new applicant and the other name) appeared in the same source together thereby establishing a further parameter for searching further sources and/or returning to previously searched data sources.

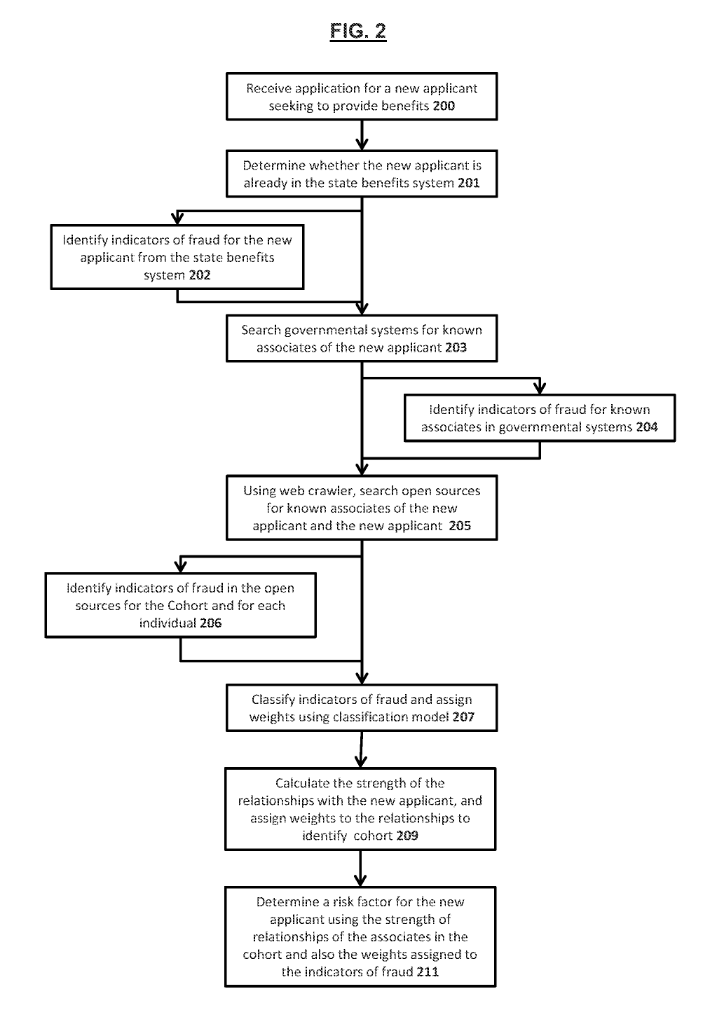

FIG. 2 is a flowchart showing the logical steps performed in an exemplary method embodiment of determining a likelihood of fraud by a cohort of fraudsters using an analysis of applications to provide government-provided benefits to the public. Method embodiments may be performed by any number of computing processors executing any number of software modules capable of performing one or more actions described herein.

In a triggering event, step 200, a computer-implemented method of identifying potential fraud may begin when a benefits system receives an application from a new applicant seeking to provide benefits to the public.

The new applicant may be an individual person, a small entity, or a larger entity. Although the exemplary embodiment of FIG. 2 describes a state-level healthcare benefits systems (e.g., Medicaid), it is to be appreciated that the disclosed subject matter is not intended to be limited to healthcare benefits systems. The benefits system may be any government-established benefits system in which public and/or private entities may provide the benefits to public recipients, such as food benefits or housing benefits.

In a first step 201, processors and modules implementing embodiments of the method may determine whether a new applicant is already found in a state benefits system. That is, using a name of a new applicant and other information about the new applicant, the system may search databases storing data regarding prior applicants to determine whether the new applicant may be found in the existing data of prior applicants.

In some embodiments, processors and modules of the system may use entity relationship modeling algorithms to determine whether the new applicant matches a prior applicant stored in the databases. In some embodiments, the system may search derivations of a name of the new applicant to determine names of prior applicants likely to be that same individual. For example, if a new applicant's name is Ronald, the system may search for Ron, Ronald, and Ronnie. After identifying prior applicants having the same and/or similar names as that of the new applicant, the system may determine a likelihood of each being the same individual based on other distinguishing characteristics, such as prior addresses, work, phone numbers, social security number derivations.

As will be detailed later, in some embodiments, after the system implements relationship modeling algorithms to determine the likelihood of the new applicant being the same person as a prior applicant, the system may use this identified individual and search for information regarding the individual in external data sources, outside of the state health benefits system and/or outside of state systems.

In a next step 202, processors and modules implementing embodiments of the method may identify one or more indicators of fraud associated with a new applicant using existing data stored in databases of the state health benefits system.

In some embodiments, processors and modules of the system may be trained to identify information consistent with fraudulent activates, or otherwise tending to predict fraudulent activities. Such embodiments may build models predictive of fraudulent activities using data of what administrators may consider indicators of fraudulent activity. Indicators may include characteristics of people, criminal history of a person, inconsistencies in information relating to people, relationships between individuals having criminal histories, types of crimes in a criminal history, activities of a person, and an expected behavioral profile consistent with activities of a person. These indicators may be associated with known types of fraudulent activities and, additionally or alternatively, these indicators may be associated with types of fraudulent activities that the indicators may predict.

As an example a new applicant may be matched to a prior applicant in the after a search of databases of a state health benefits system. The matching prior applicant my have previously lost privileges to provide benefits based on a prior incident of fraud. In other words, a prior incident of fraud committed by the prior applicant who is identified as likely being the same person as the new applicant, may be an indicator of fraud associated with the new applicant. Another example may be inconsistent information provided by the new applicant when compared against the data for the prior applicant identified as likely being the same person.

In a next step 203, processors and modules implementing embodiments of the method may search state governmental systems for known associates of the new applicant. Such governmental systems may include law enforcement criminal records, real estate records, driving records, and other sources containing data identifying people, characteristics of people, and records describing histories of people.

Embodiments of the method may search for known associates of a new applicant in databases of prior applicants in a state's health benefits system (e.g., Medicaid system). After searching internal databases of the state's health benefits system, some embodiments of the method may search for known associates of the new applicant in other governmental databases. In some embodiments, the search may iteratively proceed to other data sources, and in each iteration the search may proceed to data sources one step further removed from the databases of the internal system. For example, the search may begin with the state's Medicaid provider enrollment system, the state may extend a records search to their other accessible systems, thereby extending the ongoing search to the extended systems. The system may then search, for example, business records, driver's license records, and/or any other databases that the state may influence to add to the search capabilities.

When searching internally among prior applicants for known associates of the new applicant, embodiments of the method may compare information associated with the prior applicants and the new applicant to identify known associates. In some embodiments, modules executing entity relationship modeling algorithms may process data associated with prior applicants to find known associates in the prior applicants. Known associates may have a one or more relationships with the new applicant. Non-limiting examples of relationships between people may include shared a common work address, a common home address, a common phone number, and a common criminal history.

In some cases, people identified as having a relationship with the new applicant may be included into a cohort of people. A cohort may be a network of people and/or entities having a relationship with each other. Cohorts may be based on any number relationships defined by any number of common characteristics and/or histories. In some embodiments, algorithms identifying the cohort may be adjusted to loosen or tighten defining characteristics and/or histories of relationships between members of the cohort.

In a next step 205, processors and modules implementing embodiments of the method may identify indicators of fraud associated with identified associates in state governmental databases.

Similar to step 202, embodiments of the method may identify indicators of fraud that may be used for modeling fraudulent activities. That is, processors and modules implementing the method may be trained with predicative models to predict likelihoods of fraudulent activities. Models of fraudulent activities may be based on indicators of fraud that may be characteristics of a person, criminal histories, and other information identifying people, people's relationships, and people's personal histories. In some embodiments, members of a cohort may be determined, at least in part, based on identified indicators of fraud, or lack thereof.

As an example of step 204, an identified known associate of the new applicant in the cohort may have been previously arrested for passing bad checks. The known associate may have been identified as a prior applicant in the system but no indicators of fraud may have been found in the state's health benefits system. The search may be extended to a law enforcement database comprising records identifying convicted fraudsters. One of the models predicting fraud may identify prior convictions of crimes related to honesty (e.g., forgery, passing false identification, perjury) as an indicator of fraud. As such, the identified conviction of passing bad checks may be associated with the known associate, and in some embodiments, the indicator of fraud may be associated with the cohort.

In a next step 205, processors and modules implementing embodiments of the method may search external data sources, outside of governmental agencies. In some embodiments, processors and modules may perform this search of external data sources using a web crawler program to search open sources for information related to a new applicant, information identifying known associates, and information related to known associates.

In some embodiments, a web crawler program may search one or more open data sources, such as public websites, for information related to a new applicant. For example, a local news source may have a story about the new applicant being associated with a crime, or courthouse records may contain real property records identifying one or more prior addresses of the new applicant.

In some embodiments, a web crawler program may search one or more open data sources for information about relationships of the new applicant to other people. The web crawler may return names and information of individuals identified in sources related to the new applicant. In some cases, these individuals may be included into the cohort depending the requirements of including people into the cohort (e.g., relationship strength, prior association in their respective criminal histories).

In some embodiments, after a web crawler returns a data set comprising open sources (e.g., news reports), the data set may be processed through an entity resolution algorithm executed by processors and modules to find names of a new applicant. If the new applicant is found, then the processors and modules may search for other names within the source. Individuals who are named in the source are then associated by reference with the new applicant. In some embodiments, relationship algorithms may be applied to determine the strength of the relationship between the new applicant and the named individual found in the reference. In some embodiments, the relationship algorithms may be implemented upon identifying the individual to determine whether the individual should be included into a cohort. In some embodiments, the relationship algorithms may be executed at other steps, such as before determining a risk score for the cohort or before performing a cluster analysis to determine a risk factor, or both.

In a next step 206, processors and modules implementing embodiments of the method may identify in open data sources indicators of fraud related to one or more members of a cohort, which are related to one or more members of a cohort. That is, in some embodiments, after the identifying members of the cohort, the processors and module may identify

In some embodiments, a web crawler may send information from open sources regarding people in the cohort (i.e., the new applicant, known associates), to processing modules that may identify indicators of fraud associated with a particular person, persons, or the cohort. The processing modules may determine whether any of the people in the cohort are associated with a category of known fraudulent activity that may be modeled by indicators of fraud.

In a next step 207, processors and modules implementing embodiments of the method may classify indicators of fraud associated with one or more people in a cohort for indicators of fraud identified in state data sources and/or open data sources. Indicators of fraud may be classified into one or more categories of fraudulent activities according to predictive models identifying likely fraudulent activities based on the presence of certain indicators. That is, a predictive model for a certain fraudulent activity may associate one or more indicators of fraud with the fraudulent activity in order to predict a likelihood that the fraudulent activity may have occurred, may be ongoing, and/or may occur in the future.

In some embodiments, a weight may be assigned to recognized indicators of fraud associated with one or more people. As mentioned previously, in some embodiments, processors and modules may be trained according to models of fraudulent activities. The predictive models may predict a likelihood of fraudulent activities associated with a cohort of people according to one or more indicators of fraud for certain fraudulent activities. In some embodiments, indicators of fraud may be assigned weights in models of fraudulent activities. Processors and modules trained with such a model may recognize an indicator of fraud noted in the model for one or more people, and then assign a weight to the indicator of fraud as required by the model.

In some embodiments, a model for fraudulent may be classification model for fraudulent activities. Such classification models may classify types of fraudulent activities trained using data that a governmental entity considers to be indicators of fraud. The classification models may be trained using data of one or more governmental entities. The data may be known characteristics, activities, personal histories, and other types of information that entities may consider to be indicators of fraudulent activity. In some embodiments, processors and modules trained using such classification models may weight identified indictors of fraud associated with an individual against the classification model.

It is to be appreciated that, in some embodiments, a classification model may be a predictive model, and vice-versa. The models should not be considered mutually exclusive to one another in their respective meanings and may, in some cases, overlap.

In some embodiments, weighting of indicators of fraudulent activities may be done by an algorithm using rules (i.e., weighting by rule). In some embodiments, weighting of indicators of fraud may be done using heuristic algorithms applied in uncertain circumstances (i.e., weighting by uncertainty). Processors and modules may implement one or both of these algorithms to determine a strength of the likely fraudulence.

Weighting by rule may be algorithms in which certain indicators of fraud (e.g., activities, relationships, characteristics) may be assigned a stronger weight than other indicators based upon a predefined level of severity for indicators of fraud. A rule of a model may be developed to weight occurrences of certain indicators of fraud, such as a particular fraudulent activity, based on that rule. As a result, models may be tailored to be particularly sensitive to certain indicators of fraud according to concerns of administration and stakeholders.

As described in a previous example, if a person is found to have a prior conviction for passing bad checks for the amount of $300, then this criminal history may be an indicator of fraud that is associated with a type of fraud classification for submitting fraudulent billings. In this example, the classification model for fraudulent billings may assign a weight based on the amount associated with the fraudulent activity, so in this example, when determining the weight to assign to the identified indicator of fraud, fraudulent billings in excess of $50,000 are assigned a greater weight than fraudulent billings below $500.

Weighting by uncertainty may be algorithms that may identify inferences that a fraudulent activity has occurred, thereby identifying an indicator of fraud based on those inferences in conditions of uncertainty. Inferences of fraudulent activity may be identified based on a number of pieces of information potentially indicating fraud, but there is a lack certain the details. In some embodiments, processors and modules may not receive enough information relating to people to fulfill a rule, and some embodiments may not perform weighing using predefined rules. In such embodiments, the processors and modules may be supplied with one or more factors relating to information and perform weighting based upon what factors that are recognized. The processors and modules may then calculate a likelihood the information relating to people would fall into a classification of a fraud type and/or a predictive model.

In a next step 209, processors and modules implementing embodiments of the method may calculate the strength of relationships among members of the cohort. In some embodiments, processors and modules may calculate the strength of the relationship between people in the cohort with a new applicant. In some embodiments, processors and modules may calculate the strength of the relationships between various people in the cohort.

In some embodiments, relationship modeling algorithms may determine a strength of the relationships for people in the cohort. In such embodiments, once the system receives and/or collects names, information for people, known associates, and/or indicators of fraud associating individuals with a likelihood fraudulent activities, processors and modules of the system may build a relationship model for the cohort determining the strength of the relationships between the members of the cohort. A relationship may be defined by common characteristics, histories, and other information tending to identify and/or quantify relationships between people. Non-limiting examples of information identifying and/or quantifying relationships between people may be a common work address, a common home address, common events in criminal histories, prior business dealings, and a common phone number.

As an example, a new applicant and a prior applicant may have a common work address, a common work phone number, and common work history at the same employer for several years. In some cases, the above-listed information may present a relatively strong relationship, as opposed to, for example, two people who have done business together at some point in the past, but do not share any other distinguishing characteristics or histories. The pair of individuals who have merely done business together once, long ago, may likely have a longer distance in their relationship and thus their relationship is weaker. A relationship model may be built for strengths of relationships of each of the individuals in the cohort.

In some embodiments, processors and modules may implement relationship algorithms to determine the strength of the relationship between people in the cohort. In some embodiments, relationship algorithms may be data mining algorithms (e.g., data similarity with cross section measure). In some embodiments, relationship algorithms may apply attributes describing each individual (e.g., characteristics, histories) to determine a distance representing strength of the relationships based on the quantity and quality of similarities between individuals. In this type of relationship algorithms, the stronger that a relationship is between two people, the closer the representative distance is between those two people.

As an example, relationship distances (i.e., strengths of relationships) may be represented on a scale of zero to one, where zero is no relationship and one means that it is highly like that the two people are actually the same person. If two people are, in fact, the same person, then all of the attributes and the names would be the same or nearly the same. In such a case, the calculated distance would be 0.999 because the similarities and the strength of those similarities would be highly collated or coinciding. In the case of a married couple, when two people share many attributes, such as home addresses and last names, but different gender or different mobile phone number, their attributes may be highly collated but not completely identical. The relationship is strong because the married couple share many similarities that are highly collated, the similarities might fall within a range of 0.9 or 0.8 because it is a strong relationship, but it is not a perfect match.

In some embodiments, relationship algorithms may be used when determining whether a new applicant is the same person as a prior applicant already stored in existing data sets. In some embodiments, relationship algorithms may be used when determining whether a new applicant is the person found when searching various data sources, or whether prior applicants match a person found when searching various data sources to identify known associated of the new applicant.

In a next step 211, processors and modules implementing embodiments of the method may determine a risk factor for a new applicant using the strength of relationships of the associates in the cohort and also using the weights assigned to the indicators of fraud.

Processors and modules may determine a risk factor based on relationship strengths of a cohort, weights assigned to indicators of various types of fraudulent activities (e.g., common criminal history with associates in the cohort). In some embodiments, a cluster analysis may map correlations of these data points to determine the risk of fraud for the new applicant and the individuals of the cohort. The determined risk factor may be output to a decision-maker to decide whether or not the decision-maker should recommend the new applicant to be a healthcare benefits (e.g., Medicaid) provider. In some embodiments, when the risk factor is determined to be a certain intermediate amount, the system may automatically recommend that a decision-maker take further actions to verify activities of the new applicant. Some embodiments may recommend the further actions. Some embodiments may store and update a watch list of allowed new applicants for monitoring the activity of new applicants having a risk factor above a threshold denial value, but falling within a cautionary range.

As an example of cluster analysis, which may be used determine the risk factor of a new applicant. Cluster analysis may determine a risk score by utilizing all of the data identified or calculated, as the data relates to the cohort. That is, clustering analysis may treat the cohort of people as a system to calculate a risk score for the cohort by utilizing each of the characteristics for the cohort, including the calculated strength of relationships, and the weighting of indicators of fraud (whether fraudulent or non-fraudulent) according to the modeling of various fraudulent activities. Using the risk score, a cluster analysis may determine which cluster the new applicant and the cohort is most similar to: a high risk group, a moderate risk group, or a low risk group.

It is to be appreciated that the disclosed subject matter may be applied to any financial transaction assessment when determining risk of fraud that is committed by a cohort of people working in concert to avoid detection.

The foregoing method descriptions and the process flow diagrams are provided merely as illustrative examples and are not intended to require or imply that the steps of the various embodiments must be performed in the order presented. The steps in the foregoing embodiments may be performed in any order. Words such as “then,” “next,” etc. are not intended to limit the order of the steps; these words are simply used to guide the reader through the description of the methods. Although process flow diagrams may describe the operations as a sequential process, many of the operations can be performed in parallel or concurrently. In addition, the order of the operations may be re-arranged. A process may correspond to a method, a function, a procedure, a subroutine, a subprogram, etc. When a process corresponds to a function, its termination may correspond to a return of the function to the calling function or the main function.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the invention. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable or processor-readable storage medium. The steps of a method or algorithm disclosed herein may be embodied in a processor-executable software module which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

1. A computer-implemented method for processing applications to provide publicly-funded health benefits, the method comprising:
searching, by the computer, a first database storing one or more prior applicants associated with one or more characteristics;
identifying, by the computer, one or more associates of a new applicant having one or more characteristics of the prior applicants in the first database, wherein an associate is a prior applicant having one or more relationships to the new applicant based upon one or more characteristics common with the new applicant;
identifying, by the computer, one or more indicators of fraud in the first database associated with one or more people in a cohort comprising the new applicant and the one or more associates;
assigning, by the computer, a weight to each of the identified indicators of fraud using a classification model; and
calculating, by the computer, a risk score for the new applicant using each of the weights assigned to the one or more identified fraud indicators.

2. The method according to claim 1, further comprising determining, by the computer, whether the new applicant is a same person as a prior applicant in the first database,
wherein the new applicant is the same person as the prior applicant when a subset of the one or more characteristics of the new applicant substantially matches the subset of the one or more characteristics associated with the prior applicant.

3. The method according to claim 1, further comprising identifying, by the computer, an indicator of fraud associated with a person in the cohort from a second data source according to a model for a type of fraud.

4. The method according to claim 1, further comprising identifying, by the computer, from a search of a second data source an associate of the new applicant having a relationship with the new applicant based on one or more characteristics in common with the new applicant,
wherein the cohort of people further comprises the associate of the new applicant.

5. The method according to claim 4, further comprising:
assigning, by the computer, a second weight to each of the one or more common characteristics defining a relationship between an associate and the new applicant;
determining, by the computer, a strength of the relationship between the new applicant and the associate using the second weight of each of the one or more common characteristics, wherein the cohort comprises the associated only when the strength of the relationship with the new applicant satisfies a relationship threshold.

6. The method according to claim 5, wherein the risk score for the cohort is further determined using the strength of one or more relationships in the cohort.

7. The method according to claim 1, wherein a characteristic of an applicant is selected from the group consisting of: a name, a derivative of a name, a home address, an work address, a prior address, a familiar relation, a social security number, derivative of a social security number, and a criminal history.

8. The method according to claim 1, wherein an indicator of fraud of the cohort is selected from the group consisting of: a criminal history of a person in the cohort, a

9. The method according to claim 1, further comprising receiving, by the computer, a data source comprising one or more characteristics associated with a person in the cohort from a data-mining program automatically searching one or more data sources of a public network.

10. The method according to claim 1, further comprising receiving, by the computer, a data source comprising one or more indicators of fraud associated with the cohort from a data mining program automatically searching one or more data sources of a public network.

11. A benefits provider application system configured to mitigate fraud by a cohort, the system comprising:
a provider application database storing in memory one or more applications received from one or more prior applicants seeking to distribute a government benefit, wherein each prior applicant is associated with one or more attributes; and
a server comprising a processor configured to:
receive a new application from a new applicant having one or more attributes;
identify one or more associates having a relationship with the new applicant from the one or more prior applicants, wherein the relationship between an associate and the new applicant is based upon one or more common attributes;
identify one or more indicators of fraud for the new applicant and each of the one or more associates using one or more fraud models identifying a set of one or more attributes as being indicators of fraud; and
determine a risk factor for the new applicant based upon a risk score determined by the one or more indicators of fraud identified for the new applicant and each of the one or more associates.

12. The system according to claim 11, wherein the one or more attributes are selected from the group consisting of: characteristics of a person, a work history, a criminal history, a personal history, and a residence history.

13. The system according to claim 11, further comprising one or more government databases storing data comprising one or more attributes of the one or more prior applicants.

14. The system according to claim 11, further comprising one or more open sources having data comprising one or more attributes of the new applicant.

15. The system according to claim 14, wherein a web crawler program searches the one or more open sources for data comprising attributes of the new applicant and an associate of the new applicant having a relationship with the new applicant based on one or more common attributes.

16. The system according to claim 11, wherein the server determines a strength of a relationship based upon weights assigned to each of the attributes common between the associated and the new applicant according to a relationship model.

17. The system according to claim 11, wherein the server assigns a weight to each of the one or more identified indicators of fraud according to the one or more fraud models.

18. The system according to claim 17, wherein the server determines the risk score for a cohort of people comprising the associates and the new applicant using each of the weights assigned to the one or more indicators of fraud.
